(19) United States
(12) Patent Application Publication
(10) Pub. No.: US 2005/0265776 A1
(43) Pub. Date: Dec. 1, 2005

(54) Connecting rod for tricycles or the like and a tricycle with such a connecting rod

(76) Inventors: Heinz Kettler, Ense (DE); Karin Kettler, Ense (DE); Joachim Kettler, Ense (DE); Reinhard Rocholl, Soest (DE)

Correspondence Address: Hoffman, Wasson & Gitler, P.C.;Suite 522, Crystal Center 2, 2461 South Clark Street, Arlington, VA, 22202, US

(21) Appl. No.: 11/081,849

(22) Filed: Mar. 17, 2005

(30) Foreign Application Priority Data
Apr. 30, 2004 (DE) 20 2004 007 031.6

(51) Int. Cl. F16B 7/10

(52) U.S. Cl. 403/109.1

(57) ABSTRACT

The invention relates to a connecting rod for tricycles, the connecting rod having a first rod part and a second rod part which can be moved against one another via a slider member to change the length of the connecting rod and the slider member can be fixed in different lengths of the connecting rod by rotary motion of the rod parts against one another.

The invention relates to a connecting rod for tricycles, or the like, and a tricycle with such a connecting rod.

Connecting rods for tricycles, and tricycles with connecting rods, are known from the art. In toy shops there is currently a large selection of these tricycles and connecting rods. The disadvantage of known and commercially available connecting rods is that they have a fixed length. This length is set to individuals with average body size. These connecting rods can be unsuitable for individuals with smaller or larger body size. In particular for larger individuals, overly short connecting rods lead to uncomfortable body postures and to rapid fatigue.

It is at this which the invention is aimed.

An object of the invention is to propose a connecting rod for a tricycle, or the like, and a tricycle with such a connecting rod which is suited for individuals with different body sizes.

### SUMMARY OF THE INVENTION

This connecting rod has a first rod part and a second rod part which can be moved against one another, via a slider member, to change the length of the connecting rod. The slider member is set up such that it can be fixed, in different lengths of the connecting rod, by rotary motion of the rod parts against one another. The rod parts are turned around their axes or around their common axis. Likewise, the slider member can be released by rotary motion of the rod parts against one another in order to set the slider member to a different length.

The slider member of a connecting rod can comprise at least one hollow cylindrical first section of the first rod part. Furthermore, the slider member can comprise a second section of the second rod part which is movably arranged in the first section. The second section for this purpose advantageously has a diameter which is slightly smaller than the inside diameter of the first section.

On the second section there can be a conical outside thread. This conical outside thread can be molded on.

The slider member can also include a spreading element. This spreading element can have a conical recess.

The conical outside thread of the second section can advantageously fit into the recess of the spreading element, at least in the fixed state of the slider member. Turning the conical outside thread can establish a fixed connection between the spreading element and the second section. At the same time, the recess of the spreading element is widened by screwing in the conical outside thread, by which the outside diameter of the spreading element is increased. Since the spreading element is guided in the first section, in this way the outside surface of the spreading element can thus be placed against the inside wall of the first section and, in this way, the spreading element can be joined to the first section. Then a fixed connection between the second section with the interposition of the widened spreading element to the first section is established. The slider member is fixed in this way. To loosen the slider member, the second section is again screwed out of the spreading element, by which, on the one hand, the fixed connection between the second section, and the spreading element and on the other hand the fixed connection between the spreading element and the first section are released. The first section can then be pushed relative to the second section.

The conical recess of the spreading element can advantageously have a conical inside thread which advantageously corresponds to the outside thread of the second section.

In a connecting rod, the side walls of the spreading element can have slots in the area of the conical recess. These slots facilitate widening of the recess of the spreading element and placement of the outside walls of the spreading element against the inside walls of the first section.

So that the spreading element in the released state of the slider member in the first section of the slider member is not lost, which would prevent the slider member from being fixed again, the spreading element can be caught on the second section. This loose connection between the spreading element and the second section ensures that the slider member can be fixed again at any time.

The spreading element can have a hole for such a loose connection. Then a screw can be routed through this hole. The spreading element can be advantageously moved relative to the screw. The screw can be screwed with a threaded section in a threaded hole of the second section. The spreading element is then loosely connected by the screw to the second section.

In one alternative embodiment, the edges on the recess of the spreading element can have a collar which is pointed to the inside. The second section can then advantageously have at least one holding element which the collar of the spreading element overlaps. The holding element can be a pin which projects radially out of the remaining second section.

In another alternative embodiment of the connecting rod, to secure the spreading element against loss, in the first section of the first connecting rod, there can be a hole in the spreading element. This hole which is made in the lengthwise direction has a shoulder. The conical outside thread of the second section can be adjoined by a projection. This projection can have an undercut collar. The spreading sleeve can be seated on the second section such that the undercut collar comes to rest behind the shoulder of the hole in the spreading element. Thus the spreading element is captively secured on the second section.

### BRIEF DESCRIPTION OF THE DRAWINGS

A connecting rod as claimed in the invention is detailed using the drawings.

FIG. 1 shows a lengthwise section through the slider member of a connecting rod as claimed in the invention,

FIG. 2 shows an exploded view of the slider member,

FIG. 3 shows a view of the connecting rod in the extended state and

FIG. 4 shows a view of the connecting rod in the retracted state.

### DETAILED DESCRIPTION OF THE INVENTION

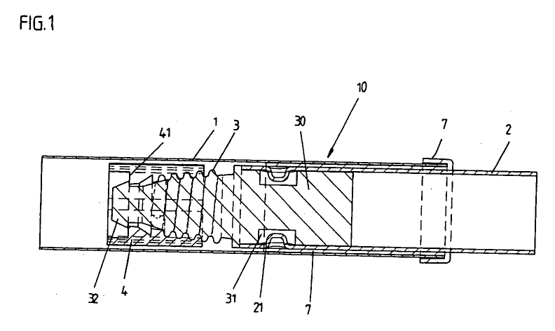

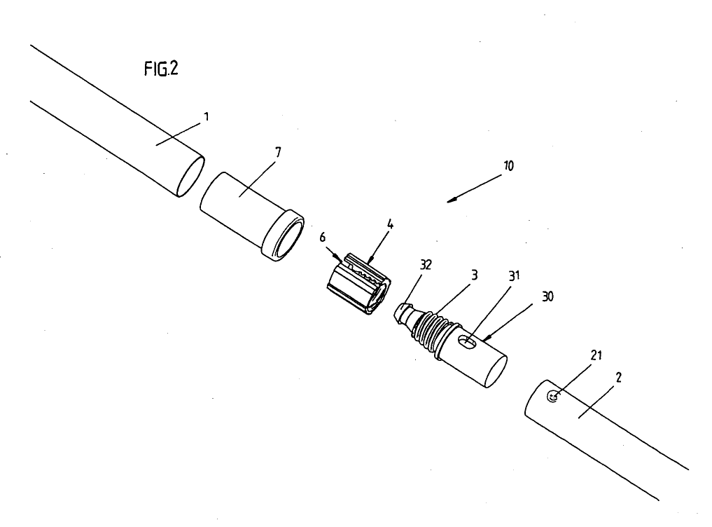

The slider member 10, shown in FIGS. 1 and 2, comprises a first section 1 of a first portion of the connecting rod which is made as a hollow cylinder. It furthermore comprises a second section 2 of a second rod part and a spreading element 4.

The end of the second section 2 is provided with a conical outside thread 3. This conical outside thread can be connected in one piece to the remaining second rod part; it is likewise possible for the conical outside thread—as in this case—to be a separate insertion part 30 and to be connected to the remaining second section via suitable connecting means 21, 31.

The insertion part 30 adjoining the conical outside thread 3 has a cylindrical section. With this cylindrical section the insertion part 30 can be inserted into the second section of the second rod part which is made a hollow cylinder like the first section 1. The insertion part 30 in the area of the hollow cylindrical section has a recess 31 in the jacket surface. After pushing the insertion part 30 into the second section 2, the rod part is pressed inward in the area of the second section 2 at the site of the recess 31. In this way, a positive connection is established between the insertion part 30 and the second section of the second rod part and prevents the insertion part 30 from turning and being pulled out. The recess 31 and the molding 21 thus form the connecting means with which the insertion part 30 is connected to the second section 2.

On the end of the insertion part 30, which adjoins the conical outside thread 3, and which faces away from the cylindrical section of the insertion part 30, the insertion part 30 has an undercut collar 32. This undercut collar 32 is used for loose connection of the insertion part 30 to the spreading element 4.

The spreading element 4 is circular in cross section and has a diameter which is dimensioned such that the spreading element 4 can be moved axially in the first section 1 in the unfixed state of the slider member 10. The spreading element 4 has a recess which passes through in the lengthwise direction. This recess is made conical in the area which faces the insertion part 30 and has a conical inside thread which interacts with the conical outside thread 3 of the second section to fix the slider member 10.

In the area facing away from the insertion part 30, the recess of the spreading element has a shoulder 41. This shoulder 41 is used to connect the spreading element 4 to the undercut collar 32 of the insertion part 30. To connect the insertion part 30 to the spreading element 4, the insertion part is inserted into the recess, the undercut collar 31 being pressed beyond the shoulder 41 into the recess. As soon as the shoulder 41 has been passed, the spreading element 4 is connected with axial play to the insertion element 30. Only when the conical outside thread 3 has been screwed into the conical inside thread of the recess is the axial play cancelled and there is a fixed connection between the insertion part 30 and the spreading element 4. Then a fixed connection is established between the spreading element 4 and the second section 2 of the second connecting rod.

The spreading element 4 has a lengthwise slot 6. This slot 6 extends over the entire height of the recess and of the spreading element 4. By screwing the conical outside thread 3 into the recess of the spreading element 4, forces act on the outside wall of the recess of the spreading element 4. They result in that the outside walls are bent to the outside. This is especially facilitated when the spreading element is made of a flexible-elastic plastic. The side wall of the recess is thus pressed against the inside wall of the first section 1. Then the spreading element is fixed relative to the first section 1. Since the second section 2 is screwed over the insertion part 30 into the spreading element 4 and is thus securely connected to the spreading element 4, the second section 2 is securely joined indirectly via the spreading element 4 to the first section 1 and the slider member 10 is fixed.

To loosen the slider member 10 the second rod part with its second section 2 and with the conical outside thread 3 with the opposite direction of rotation is screwed out of the recess of the spreading element 4. The side wall of the spreading element 4 which is bent to the outside thus springs back and releases the connection of the first section 1 of the first rod part.

So that in the released state of the slider member 10 the spreading element 4 is not lost in the first section 1, the spreading element 4 is caught on the second section 2. As already described, the undercut collar 32 of the insertion part 30 and the shoulder 41 of the spreading element 4 are used for this purpose. The spreading element 4 can thus be axially moved with play relative to the second section; it is however at the same time captively connected to the second section 2.

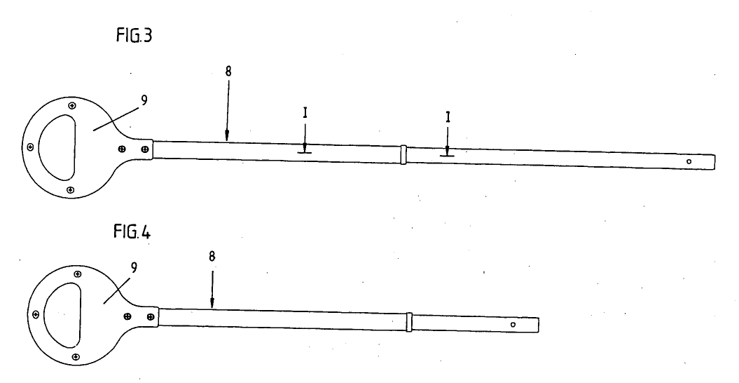

FIGS. 3 and 4 show the connecting rod 8 with a slider member as shown in FIGS. 1 and 2. This connecting rod has a handle 9 which is attached to the first rod part via screws.

A bearing sleeve 7 is pushed into the end of the first section 1. This bearing sleeve 7 is made of plastic and is designed to prevent direct contact between the sections 1, 2 of the first and second rod part, which sections are generally made of metal.

Via the slider member 10 it is possible to push the first rod part and the second rod part of the connecting rod against one another. The displacement path is determined essentially by the length of the hollow cylindrical first section 1 of the first rod part. By simply turning in one direction the slider member 10 is fixed and by rotary motion in the other direction of rotation the slider member 10 can be released again.

1. A connecting rod for tricycles,
the connecting rod comprising a first rod part and a second rod part which can be moved against one another via a slider member to change a length of the connecting rod,
the slider member can be fixed in different lengths of the connecting rod by a rotary motion of the rod parts against one another.

2. The connecting rod as claimed in claim 1, wherein the slider member comprises at least one hollow cylindrical first section of the first rod part.

3. The connecting rod as claimed in claim 2, wherein the slider member further comprises a second section of the second rod part which is movably arranged in the first section.

4. The connecting rod as claimed in claim 3, wherein the second section has a conical outside thread.

5. The connecting rod as claimed in claim 2, wherein the slider member further comprises a spreading element.

6. The connecting rod as claimed in claim 5, wherein the spreading element has a conical recess.

7. The connecting rod as claimed in claim 6, wherein the conical outside thread fits into a recess of the spreading element at least in the fixed state of the slider member.

8. The connecting rod as claimed in claim 6, wherein the conical recess has a conical inside thread.

9. The connecting rod as claimed in claim 5, wherein side walls of the spreading element have one or more slots at least in the area of the conical recess.

10. The connecting rod as claimed in claim 5, wherein the spreading element has a hole.

11. The connecting rod as claimed in claim 10, wherein a screw is routed through the hole.

12. The connecting rod as claimed in claim 11, wherein the spreading element can be moved relative to the screw.

13. The connecting rod as claimed in claim 11, wherein the screw is screwed in a threaded hole of the second section.

14. The connecting rod as claimed in one of claim 6, wherein the spreading element on edges of the recess has a collar which is pointed to an inside.

15. The connecting rod as claimed in claim 14, wherein the second section of the second rod part has at least one holding element which overlaps the collar of the spreading element.

16. The connecting rod as claimed in claim 15, wherein the holding element is a pin which projects radially out of the remaining second section.

17. The connecting rod as claimed in claim 10, wherein the hole has a shoulder opposite the conical inside thread.

18. The connecting rod as claimed in claim 17, wherein the conical outside thread is adjoined by a projection with an undercut collar.

19. The connecting rod as claimed in claim 18, wherein the undercut collar is located in the hole behind the shoulder in order to protect the spreading element against loss.

20. A tricycle comprises a connecting rod as claimed in claim 1.
